(19) United States
(12) Patent Application Publication
(10) Pub. No.: US 2007/0129081 A1
(43) Pub. Date: Jun. 7, 2007

(54) Local congestion-avoidance method in wireless personal area network

(75) Inventors: Eun-il Seo, Suwon-si (KR); Jin-young Yang, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/514,956

(22) Filed: Sep. 5, 2006

(30) Foreign Application Priority Data
Dec. 2, 2005 (KR) 10-2005-0117218

(51) Int. Cl. H04Q 7/20

(52) U.S. Cl. 455/453

(57) ABSTRACT

A local congestion-avoidance method in a wireless personal area network includes receiving data from a plurality of sensor nodes, generating a congestion-avoidance response signal with respect to the data first received, and broadcasting the congestion-avoidance response signal to the plurality of sensor nodes. The data may include, for example, a source address, a destination address, a sequence number, and a control frame. The control frame may include, for example, congestion-related information, a sequence number, a source address, and a destination address.

### CROSS-REFERENCE TO RELATED APPLICATIONS

This application claims priority from Korean Patent Application No. 10-2005-0117218 filed on Dec. 2, 2005, in the Korean Intellectual Property Office, the entire disclosure of which is incorporated herein by reference.

### BACKGROUND OF THE INVENTION

1. Field of the Invention

Methods and apparatuses consistent with the present invention relate to local congestion-avoidance in a wireless personal area network (WPAN). More particularly, the present invention relates to a local congestion-avoidance method in the WPAN for avoiding congestion in a such a manner that a relay node broadcasts a response signal comprising congestion-related information with respect to data transmitted to the relay node from a certain sensor node, and then adjacent sensor nodes learn the state of the certain sensor node by referring to the congestion-related information comprised in the response signal in, for example, a low-rate ZigBee™ system used for short-range communications.

2. Description of the Related Art

The Institute of Electrical and Electronics Engineers (IEEE) 802.15 Working Group developed the WPAN to standardize short-distance, wireless networks. The IEEE 802.15 standard has four Task Groups. More particularly, among them, IEEE 802.15.1 standardizes the Bluetooth® technology, whereas IEEE 802.15.3 and IEEE 802.15.3a standardize the high-rate WPAN. Additionally, IEEE 802.15.4, also known as ZigBee™, standardizes low-rate WPAN, which corresponds to data rates less than 250 Kbps.

Although ZigBee™ cannot deliver as much data per unit time as Bluetooth®, it is the low-power standard because a single battery can last about one year. In addition, ZigBee™ minimizes the number of software-relevant parts to halve the cost in comparison with Bluetooth®. Thus, it can be said that ZigBee™ is the wireless communication technique suitable for the home network which is established based on the control and the sensor. Moreover, ZigBee™ can support many more components than IEEE 802.15.1 Bluetooth®.

FIGS. 1A and 1B are conceptual diagrams illustrating a data transmission and reception method in a ZigBee™ system of the related art.

The related-art ZigBee™ system includes a plurality of sensor nodes 110 and 130, and a coordinator 120.

The sensor nodes 110 and 130 transmit data, destined for a destination, to the coordinator 120. The coordinator 120 receives the data from the sensor nodes 110 and 130, replies to the sensor nodes 110 and 130 with response data, and relays the data received from the sensor nodes 110 and 130 to the destination.

The sensor nodes are part of at least one router device.

In FIG. 1A, the first sensor node 110 transmits data to the coordinator 120 (S1). Subsequently, the second sensor node 130 transmits data to the coordinator 120 (S2).

At this time, the data transmitted from the first sensor node 110 to the coordinator 120 comprises: source address “Src=A”, destination address “Dst=B”, sequence number “SN=0×70”, and “Control Frame”.

The data transmitted from the second sensor node 130 to the coordinator 120 comprises: “Control Frame”, sequence number “SN=0×80”, destination address “Dst=B”, and source address “Src=C”. The sequence number 132 (0×80) of the data transmitted from the second sensor node 130 is different from the sequence number (0×70) of the data transmitted from the first sensor node 110.

While the coordinator 120 receives the data from both the first sensor node 110 and the second sensor node 130, the data from the first sensor node 110 is received first. Thus, the coordinator 120 recognizes the reception of the data from the first sensor node 110 and broadcasts a response signal to the sensor nodes 110 and 130 (S3). This is because the respective nodes in the ZigBee™ system receive one data at a time and receive next data after sending a response signal for the previous data.

The response signal broadcast from the coordinator 120 to the sensor nodes 110 and 130 comprises: “Control Frame”, sequence number “SN=0×70”, and frame check sequence “FCS”. The sequence number is the sequence number of the first sensor node 110.

Accordingly, the second sensor node 130 cannot receive the response signal in reply to its transmitted data. In case that the sequence number 132 of the data transmitted from the second sensor node 130 is the same as the sequence number 0×70 of the data transmitted from the first sensor node 110, the second sensor node 130 incorrectly believes that the coordinator 120 has received its transmitted data. As a result, it is disadvantageous that the data is not accurately transmitted between the coordinator 120 and the second sensor node 130.

In case that the coordinator 120 receives data from a plurality of sensor nodes at the same time, congestion arises due to the bottleneck of buffer overflow.

Furthermore, since the coordinator 120 broadcasts the response signal, the sensor nodes cannot know whose data the response signal corresponds to and who is to receive the response signal. In brief, the second sensor node 130 is likely to misunderstand that the response signal corresponds to its transmitted data.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a local congestion-avoidance method in the WPAN, for avoiding the congestion in a such a manner that a relay node broadcasts a response signal comprising congestion-related information with respect to data transmitted to the relay node from a certain sensor node, and then adjacent sensor nodes learn the state of the certain sensor node by referring to the congestion-related information comprised in the response signal in, for example, a low-rate ZigBee™ system used for short-range communications.

To accomplish the above aspect of the present invention, a local congestion-avoidance method in a WPAN includes receiving data from a plurality of sensor nodes; generating a congestion-avoidance response signal with respect to the data first received; and broadcasting the congestion-avoidance response signal to the plurality of sensor nodes.

The data may comprise a source address, a destination address, a sequence number, and a control frame.

The congestion-avoidance response signal may comprise a control frame comprising congestion-related information, a sequence number, a source address, and a destination address.

The sequence number may be a sequence number of the sensor node which transmits the data first received.

The control frame comprising the congestion-related information may indicate the congestion-related information in two bits reserved as a flag.

The congestion-related information may be indicated in other reserved bits of the control frame as a 2-bit flag.

In the reserved two bits, the flag 00 may denote no congestion, the flag 01 may denote a congestion warning, the flag 10 may denote congestion, and the flag 11 may denote congestion and overflow.

The congestion-avoidance response signal may be generated in a first layer. The congestion-avoidance response signal may be generated by determining whether a buffering status exceeds a threshold based on a medium access control (MAC) management information base (MIB) in a second layer.

The plurality of sensor nodes may change a transmission path based at least in part on the congestion-avoidance response signal. The plurality of sensor nodes may change a data transmission path based at least in part on the congestion-related information comprised in the congestion-avoidance response signal.

### BRIEF DESCRIPTION OF THE DRAWINGS

The above aspects of the present invention will be more apparent by describing exemplary embodiments of the present invention, with reference to the accompanying drawings, in which:

FIGS. 1A and 1B are conceptual diagrams illustrating a data transmission method in a ZigBee™ system of the related art;

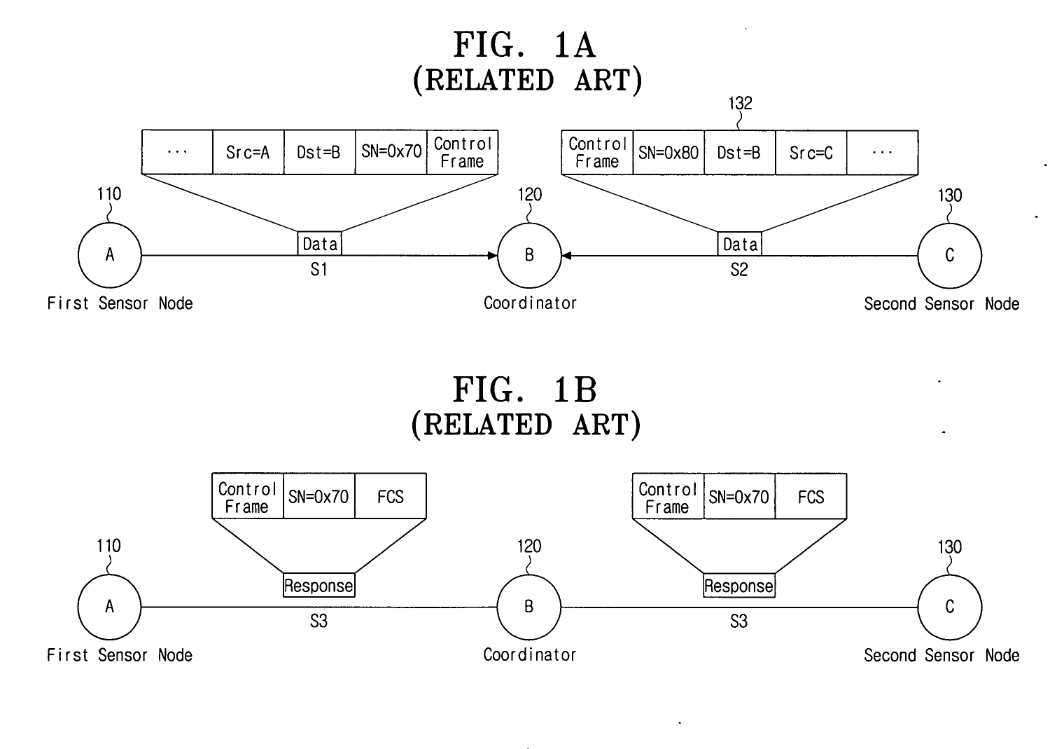

FIGS. 2A and 2B are conceptual diagrams illustrating a local congestion-avoidance method in a WPAN according to an exemplary embodiment of the present invention;

FIG. 3 is a diagram illustrating a format of a control frame comprising congestion-related information according to an exemplary embodiment of the present invention; and

FIG. 4 is a diagram illustrating a case when adjacent nodes change their transmission path based at least in part on a congestion-avoidance response signal according to an exemplary embodiment of the present invention.

### DETAILED DESCRIPTION OF THE EXEMPLARY EMBODIMENTS

Certain exemplary embodiments of the present invention will now be described in greater detail with reference to the accompanying drawings.

In the following description, the same drawing reference numerals are used to refer to the same elements, even in different drawings. The matters defined in the following description, such as detailed construction and element descriptions, are provided as examples to assist in a comprehensive understanding of the invention. Also, well-known functions or constructions are not described in detail, since they would obscure the invention in unnecessary detail.

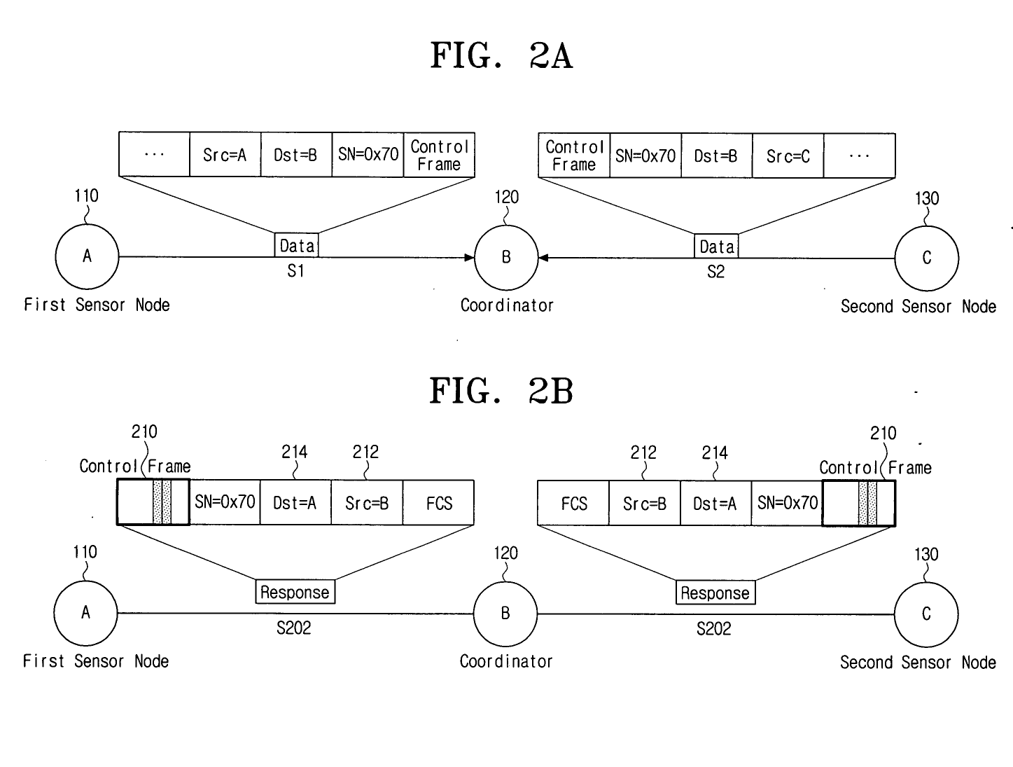

FIGS. 2A and 2B are conceptual diagrams illustrating a local congestion-avoidance method in a WPAN according to an exemplary embodiment of the present invention.

In FIG. 2A, a first sensor node 110 transmits data to a coordinator 120 (S1), and subsequently, a second sensor node 130 transmits data to the coordinator 120 (S2).

The data transmitted from the first sensor node 110 to the coordinator 120 comprises: source address “Src=A”, destination address “Dst=B”, sequence number “SN=0×70”, and “Control Frame”.

The data transmitted from the second sensor node 130 to the coordinator 120 comprises: “Control Frame”, sequence number “SN=0×70”, destination address “Dst=B”, and source address “Src=C”. The sequence number (0×70) of the data transmitted from the second sensor node 130 to the coordinator 120 is the same as the sequence number (0×70) of the data transmitted from the first sensor node 110.

In FIG. 2B, the coordinator 120 broadcasts a congestion-avoidance response signal with respect to the first sensor node 110 according

As shown in FIG. 2B, the coordinator 120 receives the data from the respective sensor nodes 110 and 130. Because the data from the first sensor node 110 is received first, the coordinator 120 broadcasts the response signal with respect to the first sensor node 110 to all the sensor nodes (S202).

In the exemplary embodiment of the present invention, the response signal is the congestion-avoidance response signal which comprises a control frame 210 comprising the congestion-related information, a sequence number, a source address 212, and a destination address 214.

In more detail, the coordinator 120 broadcasts the congestion-avoidance response signal with respect to the first sensor node 110 to the respective sensor nodes including the first sensor node 110. In doing so, the sequence number in the congestion-avoidance response signal is the sequence number of the first sensor node 110. The congestion-related information comprised in the control frame 210 indicates its congestion state using a 2-bit flag.

Accordingly, the first sensor node 110 receives the definite response signal in relation to its transmitted data, and the other sensor nodes—including the second sensor node 130—recognize, based on the congestion-avoidance response signal, that their transmitted data did not arrive at the destination. Also, the other sensor nodes—including the second sensor node 130—can confirm whether the coordinator 120 is congested from the congestion-avoidance response signal broadcast from the coordinator 120.

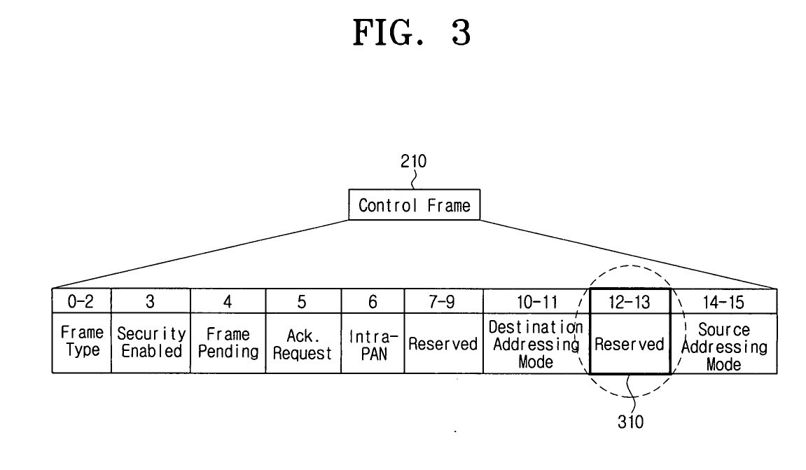

FIG. 3 is a diagram illustrating a format of the control frame 210 comprising the congestion-related information according to an exemplary embodiment of the present invention.

Referring now to FIG. 3, the control frame 210, which is comprised in the congestion-avoidance response signal transmitted from the coordinator 120 to the sensor nodes, consists of, for example, a three-bit frame type, a one-bit security enabled, a one-bit frame pending, a one-bit acknowledgement request, a one-bit intra-PAN, a three-bit reserved, a two-bit destination addressing mode, a two-bit reserved, and a two-bit source addressing mode.

In the exemplary embodiment of the present invention, the node congestion-related information is indicated in the 13^{th} and 14^{th} reserved two bits 310 (designated as 12-13) in the control frame 210 of the response signal, as the flag.

The other sensor nodes, including the first sensor node 110 and the second sensor node 130 receiving the congestion-avoidance response signal, can learn the congestion state of the coordinator 120 by recognizing the flag in the reserved two bits 310 in the control frame 210 of the received congestion-avoidance response signal.

In other words, a node, like the coordinator 120, can inform its adjacent nodes of its state by merely transmitting the response signal to the other sensor nodes, including the second sensor node 130, without having to transmit additional data to inform them of the congestion state.

Note that the congestion-related information can be carried by two bits of the 8^{th} through 10^{th} reserved bits (designated as 7-9), by way of example, rather than the 13^{th} and 14^{th} reserved two bits 310 (designated as 12-13) of the control frame 210. In this situation, Table 1 shows the 2-bit congestion-related information.

TABLE 1

| Flag | Description |
|---|---|
| 00 | No congestion control |
| 01 | There is sign for congestion |
| 01 | There is congestion |
| 11 | Congestion and overflow |

As shown in Table 1, in the control frame 210 of the coordinator 120, the flag 00 of the reserved two bits 310 denotes no congestion, the flag 01 denotes a congestion warning, the flag 10 denotes congestion, and the flag 11 denotes congestion and overflow.

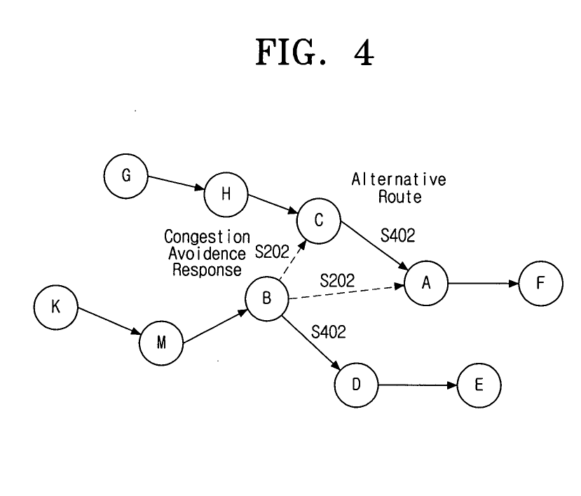

FIG. 4 is a diagram illustrating a case when adjacent nodes change their transmission path according to a congestion-avoidance response signal according to an exemplary embodiment of the present invention.

The congestion-avoidance response signal of the present invention differs from the response signal of the related art in that the congestion-avoidance response signal comprises the source address 212 and the destination address 214.

The source address 212 indicates the identification of the node information of the congestion state. Since the adjacent nodes can recognize the congestion state of the node of the source address 212, they refer to the source address 212 to establish their communication paths.

The destination address 214 indicates a node which is to receive the congestion-avoidance response signal. The other sensor nodes, excluding the first sensor node 110 transmitting the data, can recognize from the destination address 214 that their transmitted data has not arrived. Thus, the other sensor nodes retransmit the data.

Referring to FIG. 4, a node B, which serves to relay data, broadcasts a congestion-avoidance response signal to a plurality of sensor nodes (S202). A node A and a node C receive the congestion-avoidance response signal. It is assumed that the congestion-related information comprised in the control frame of the congestion-avoidance response signal, for example, the flag 11 in the reserved two bits 310, indicates congestion and overflow.

The node A and the node C, upon receiving the congestion-avoidance response signal, recognize that the node B is congested from the congestion-avoidance response signal. Hence, the node C changes the node B to the node A in the transmission path. And the node B changes the node A to a node D (S402). As a result, the node B can avoid the bottleneck caused by the data transmission.

When generating the congestion-avoidance response signal to broadcast to the plurality of sensor nodes, the node B sets the congestion-related information to the flag based on the buffering status. Particularly, when the buffering status exceeds a threshold k, the node B sets the flag 11 in the reserved two bits 310 in the control frame 210, by way of example. In doing so, the node B generates the congestion-avoidance response signal in the first layer, and determines whether the buffering status exceeds the threshold based on the MAC MIB in the second layer.

After the other sensor nodes, receiving the congestion-avoidance response signal from the node B, change their transmission path based at least in part on the congestion-avoidance response signal, there is less data or no data transmitted to the node B. Therefore, the node B has less overhead.

Meanwhile, when data is transmitted from the node B to the node C, the node B fetches a first entry from a routing table and compares it with the destination address of the data. In more detail, it is compared whether a value stored in the destination field of the first entry of the routing table matches the destination address. When the two compared values match, the node B forwards the data along the path to the corresponding destination node.

In view of the foregoing as set forth above, there is no need to transmit additional data to inform the node congestion state in the WPAN.

Reliable data transmission can be achieved between the nodes based on the source address and the destination address. Additionally, since a node informs its adjacent nodes of its congestion state, the transmission rate can be increased by changing the transmission paths.

Furthermore, it is possible to avoid the bottleneck of buffer overflow.

While the present invention has been particularly shown described with reference to exemplary embodiments thereof, it will be understood by those skilled in the art that various changes in form and details may be made therein without departing from the spirit and scope of the invention as defined by the appended claims.

What is claimed is:

1. A local congestion-avoidance method in a wireless personal area network, the method comprising:
receiving data from a plurality of sensor nodes;
generating a congestion-avoidance response signal with respect to the data first received; and
broadcasting the congestion-avoidance response signal to the plurality of sensor nodes.

2. The method of claim 1, wherein the data comprises:
a source address;
a destination address;
a sequence number; and
a control frame.

3. The method of claim 1, wherein the congestion-avoidance response signal comprises a control frame comprising:
congestion-related information,
a sequence number,
a source address, and
a destination address.

4. The method of claim 3, wherein the sequence number is a sequence number of a sensor node which transmits the data first received.

5. The method of claim 3, wherein the control frame comprising the congestion-related information comprises two bits reserved as a two-bit flag.

6. The method of claim 5, wherein the control frame indicates the congestion-related information in the two bits reserved as the two-bit flag.

7. The method of claim 5, wherein the control frame indicates the congestion-related information in two bits other than those reserved as the two-bit flag.

8. The method of claim 5, wherein in the reserved two bits, a flag 00 denotes no congestion, a flag 01 denotes a congestion warning, a flag 10 denotes congestion, and a flag 11 denotes congestion and overflow.

9. The method of claim 1, wherein the congestion-avoidance response signal is generated in a first layer.

10. The method of claim 9, wherein the congestion-avoidance response signal is generated by determining whether a buffering status exceeds a threshold based on a medium access control management information base in a second layer.

11. The method of claim 1, wherein the plurality of sensor nodes changes a transmission path based at least in part on the congestion-avoidance response signal.

12. The method of claim 11, wherein the plurality of sensor nodes changes a data transmission path based at least in part on congestion-related information comprised in the congestion-avoidance response signal.

13. The method of claim 1, wherein the wireless personal area network uses IEEE 802.15.1 Bluetooth® technology.

14. The method of claim 1, wherein the wireless personal area network uses IEEE 802.15.3 technology.

15. The method of claim 1, wherein the wireless personal area network uses IEEE 802.15.3a technology.

16. The method of claim 1, wherein the wireless personal area network uses IEEE 802.15.4 ZigBee™ technology.
